(19) United States
(12) Patent Application Publication
(10) Pub. No.: US 2010/0084224 A1
(43) Pub. Date: Apr. 8, 2010

(54) MACHINE MOUNTING IN A MACHINE ROOMLESS ELEVATOR SYSTEM

(75) Inventor: Zhiying Hao, Tianjin (CN)

Correspondence Address: CARLSON GASKEY & OLDS, 400 W MAPLE STE 350, BIRMINGHAM, MI, 48009, US

(73) Assignee: OTIS ELEVATOR COMPANY, Farmington, CT (US)

(21) Appl. No.: 12/529,791

(22) PCT Filed: Mar. 12, 2007
(86) PCT No.: PCT/CN2007/000771

§ 371 Date: Sep. 3, 2009

(51) Int. Cl. B66B 7/02; B66B 11/08

(52) U.S. Cl. 187/254; 187/406

(57) ABSTRACT

An elevator system includes a car (2) and a counterweight (4) configured to travel along guide rail units (6; 8) and a machine (12) being positioned above the car (2) and configured to drive a tension member (10). In addition, the machine (12) is mounted on an overhead structure (20) and the overhead structure (20) is supported only by the guide rail units (6; 8). This mounting arrangement avoids contact between the overhead structure and the elevator hoistway in the building, and isolates transfer of vibration and noise and improves the load bearing conditions of the walls of the building.

### TECHNICAL FIELD

The present invention relates to an elevator system, specifically to a machine-roomless elevator system.

### BACKGROUND ART

Conventional traction elevator systems comprise a car and a counterweight which are respectively hung on opposite two ends of a hoisting cable in the elevator hoistway. The hoisting cable is driven by a driving pulley which is driven for rotation by an electric machine. In the conventional elevator systems, the electric machine is provided in the machine room. Generally, the machine room is built above the hoistway to receive the electric machine and provide sufficient room for an elevator repairer to maintain the equipment disposed therein.

In a building, a machine room for each elevator causes more and more problems in industry. Firstly, for the proprietors of the building, to build a machine room will obviously lead to higher charges; secondly, real estate scarcity induces space constraints that make it desirable to use space for other purposes. When a building has multiple elevators, these factors and shortcomings become more magnified because each elevator needs a machine room, thereby increasing the building expenditure and occupying other spaces in the building. Therefore, some machine-roomless elevator systems are developed in the elevator industry.

The prior art machine-roomless elevator system comprises an electric machine provided in the hoistway. Generally, the electric machine is directly supported on the inner walls of the hoistway. This requires the walls of the building to bear the weight of the electric machine, and during operation of the elevator, the shock and noise generated by the elevator are constantly transferred to the walls of the building, which could cause damage to the structure of the building.

WO2005/007552 has disclosed an elevator mounting its dead end hitches on the bed plate of a machine roomless elevator. In this elevator, a machine 24 is provided adjacent or aside to a cantilever car 22, which occupies an additional space in the hoistway when viewing in the plan view of the mounted elevator and causes some difficulties in the arrangement of various components of the elevator.

### SUMMARY OF THE INVENTION

Exemplary embodiments of the invention include an elevator system including a car and a counterweight configured to travel along guide rail units and a machine being positioned above the car and configured to drive a tension member. In addition, the machine is mounted on an overhead structure and the overhead structure is supported only by the guide rail units. This mounting arrangement avoids contact between the overhead structure and the elevator hoistway in the building, and isolates transfer of vibration and noise and improves the load bearing conditions of the walls of the building.

In addition, to cater to the structures of most of elevator hoistways currently available in the market, in an elevator system according to the present invention, preferably the counterweight is disposed in the rear of the car, i.e., opposite to the location of the door of the car. Further, the machine is positioned above the car. In this way, in the application of the present invention, innovations to the prior art elevator system can be realized without changing the hoistway structure, and construction workload can be substantially reduced. In other words, the cross-sectional area of the hoistway is not to be increased by providing components aside the car.

### BRIEF DESCRIPTION OF THE DRAWINGS

The embodiments of the present invention will be described with reference to the figures, of the figures:

FIG. 1 is a view showing traction principle of a general elevator system;

FIG. 2 is a perspective view of the whole structure of the elevator system of a preferred embodiment according to the present invention;

FIG. 3 is a perspective view of an overhead structure of the elevator system shown in FIG. 2;

FIG. 4 is a perspective view of a bedplate in the overhead structure shown in FIG. 3;

FIG. 5 is a perspective view of a car dead end hitch in the overhead structure shown in FIG. 3;

FIG. 6 is a perspective view of the bracket connecting the bedplate or the car dead end hitch and the corresponding guide rails; and

FIG. 7 is an exploded perspective view of the connection locations between the brackets and the corresponding beams shown in FIG. 6 from another perspective.

### DETAILED DESCRIPTION

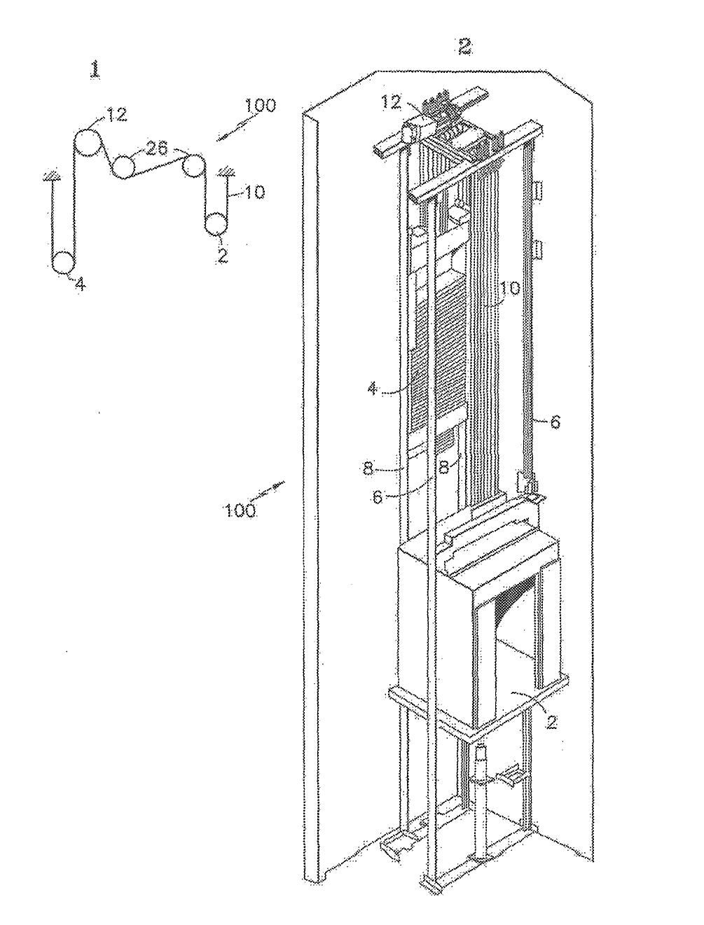

FIG. 1 shows the traction principle of an elevator system. The elevator system 100 comprises a car 2, a counter weight 4 and a machine 12. The counterweight 4 is located at the rear of the car 2 and the machine 12 is positioned over the car 2. It is understood that either the entire machine 12 or at least a portion of the machine 12 can be positioned over the car. A tension member 10 connecting the car to the counter weight 4 engages with a deflection sheave assembly 26 including two deflection sheaves for traction, wherein the tension member 10 winds above one deflection sheave and beneath the other deflection sheave such that the tension member 10 and the car 2 and the counter weight 4 into movement when the machine 12 operates and the deflection sheaves rotate. It is understood that this structure is only for illustration. As for use of specific members, the machine 12 according to the present invention can be a gear-type electrical machine or gearless electrical machine, and the tension member 10 can be a round rope or a flat belt.

FIG. 2 shows a perspective view of the whole structure of the elevator system of an exemplary embodiment according to the present invention. As shown in FIG. 2, the whole elevator system 100 is disposed in an elevator hoistway in a building and comprises the car 2, the counter weight 4 and the machine 12, as depicted in FIG. 1. In addition, the system 100 is provided with a pair of car guide rails 6 and a pair of counter weight guide rails 8 that are parallel to each other. The car 2 and the counter weight 4 respectively travel along the car guide rails 6 and the counter weight guide rails 8. These guide rails are connected to the ground at their respective bottom ends, and are connected to the inner walls of the hoistway at several connection points in their respective longitudinal directions to acquire supporting. A person having ordinary skill in the art can understand that the number of guide rails may not be limited to this, for example, a single guide rail or more than two guide rails can be used to guide the car and the counterweight. In another solution, the structure of the guide rails can vary, for example, the pair of counterweight guide rails can be hollow and two counterweight portions can be respectively disposed into the pair of hollow guide rails.

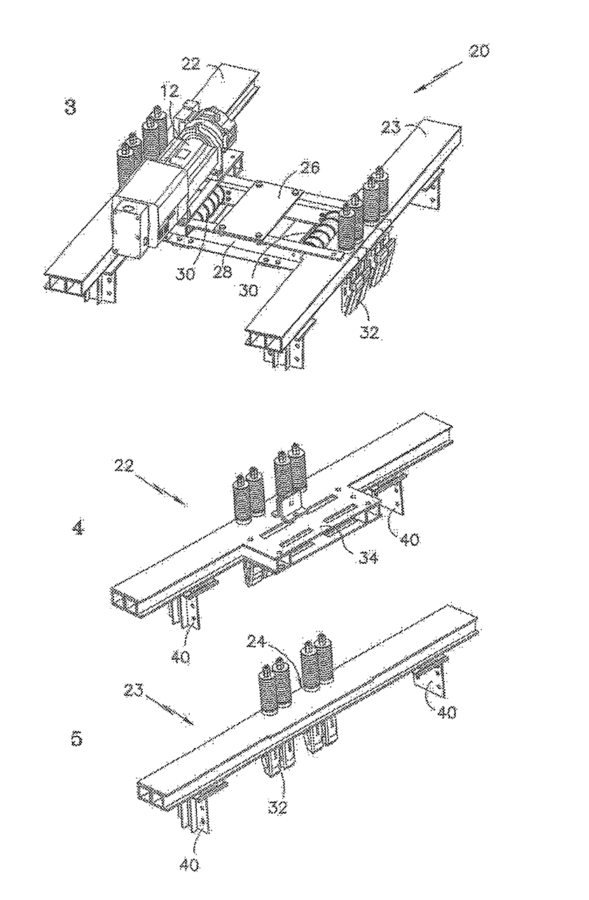

FIG. 3 shows an overhead structure 20 of the elevator system 100. The machine 12 is mounted on the overhead structure. Specifically, the overhead structure 20 comprises a first plate 22 for mounting the machine 12 and fastening one end of several tension members 10 (not shown in FIG. 3), and a second plate 23 for mounting a car dead end hitch 24 that fastens another end of the several tension members 10, and further comprises the deflection sheave assembly 26 connected between the bedplate and the car dead end hitch. Several clamps 32 are provided for clamping the ends of the tension member 10. The deflection sheave assembly 26 comprises a frame 28 that bridges the first and second plates 22, 23. The two sets of pulleys 30 are received in the frame 28. The tension member 10 winds above one set of pulleys and beneath the other set of pulleys.

FIG. 4 shows a more detailed view of the first plate 22. Referring to FIGS. 3 and 4, at the middle portion of the first plate 22 is provided an extension 34 protruding towards the second plate; the machine 12 is fixedly disposed on the extension 34. Referring to FIGS. 2 and 4, the first plate 22 is connected, at both ends thereof, to the top ends of the pair of counter guide rails 8 respectively through brackets 40. It is noticeable herein that the first plate 22 is supported only through the pair of counterweight guide rails 8 and without contact with the elevator hoistway in the building, which isolates transfer of vibration and noise and improves the load bearing conditions of the walls of the building.

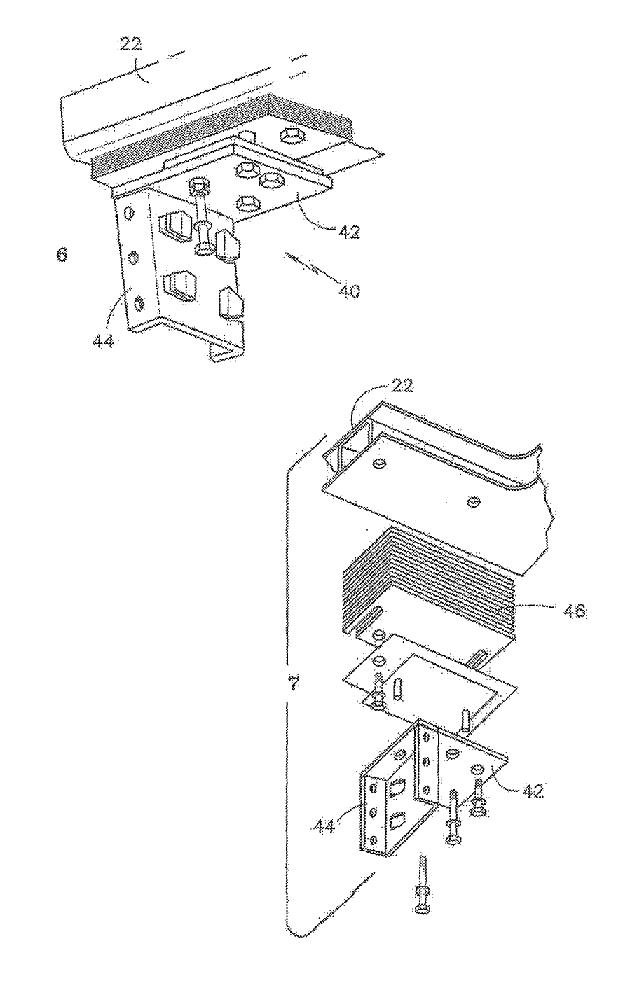

Likewise, referring to FIG. 2 and FIG. 5, the second plate 23 is connected, at both ends thereof, to the top ends of the pair of car guide rails 6. The second plate is supported only through the pair of car guide rails 6 and without contact with the elevator hoistway in the building, which isolates transfer of vibration and noise and improves the load bearing conditions of the walls of the building. A person having ordinary skill in the art should understand herein that the first plate 22 can also be connected to the car guide rails and the second plate 23 can also be connected to the counterweight guide rails.

Referring to FIG. 4 and FIG. 5, the first and second plates 22, 23 are made of two C-channel steel profiles arranged side by side. It can also be understood that the first and second plates 22, 23 can also be made of various materials with various structures universally used in the art, for example, they can be shaped into I-beams.

FIG. 6 is a perspective view of the brackets 40 that connect the first plate 22 to the corresponding guide rails. As shown in the figure, the bracket 40 is a L-shaped bracket and comprises a horizontal arm 42 and a vertical arm 44 that are perpendicular to each other, wherein the horizontal arm 42 can be fixed to the underside of the first plate 22 by fastening means such as a bolts, and the vertical arm 44 is fixed to the top ends of the corresponding guide rails through fastening means such as bolts. The same configuration also applies to the second plate 23 (not shown).

FIG. 7 shows an exploded perspective view of the connection locations between the brackets 40 and the corresponding beams. As shown, stacks 46 of rubber blocks can be disposed between the first plate 22 and the relevant horizontal arm 42 of the bracket as shock-absorbing means. Although not shown, the same configuration also applies to the second plate 23.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An elevator system, comprising:
a car and a counterweight that are configured to travel along guide rail units;
a machine being positioned above the car and configured to drive a tension member;
an overhead structure on which the machine is mounted;
wherein the overhead structure is supported only by the guide rail units.

2. The elevator system as claimed in claim 1, wherein the guide rail units comprise at least one car guide and at least one counterweight guide.

3. The elevator system as claimed in claim 2, wherein the counterweight is provided at a rear of the car.

4. The elevator system as claimed in claim 2, wherein the counterweight is provided laterally relative to the car.

5. The elevator system as claimed in claim 2, wherein the at least one counterweight guide rail comprises a pair of hollow counterweight guide rails, and the counterweight comprises two counterweight portions respectively provided in the hollow guide rails.

6. The elevator system as claimed in claim 2, wherein the overhead structure comprises a bedplate for mounting the machine and a car dead end hitch for fastening the tension member that are opposed to each other, and a deflection sheave assembly connected between the bedplate and the car dead end hitch, wherein the bedplate is connected to one of the at least one car guide rail and the at least one counterweight guide rail via a bracket, and wherein the car dead end hitch is connected to the other of the at least one car guide rail and the at least one counterweight guide rail via a bracket.

7. The elevator system as claimed in claim 6, wherein the bedplate and the car dead end hitch are both made of C-channel steel profiles.

8. The elevator system as claimed in claim 6, wherein the bracket comprises two arms perpendicular to each other, one arm being fixed to the bedplate or the car dead end hitch, and the other arm being fixed to a corresponding guide rail.

9. The elevator system as claimed in claim 8, wherein shock-absorbing means are disposed between the bedplate or the car dead end hitch and the arm of the relevant bracket.

10. The elevator system as claimed in claim 1, wherein the tension member is a round rope.

11. The elevator system as claimed in claim 1, wherein the tension member is a flat belt.

12. The elevator system as claimed in claim 1, wherein the machine is an electric machine.
